(19) United States
(12) Patent Application Publication
(10) Pub. No.: US 2005/0175242 A1
(43) Pub. Date: Aug. 11, 2005

(54) Online handwritten character input device and method

(75) Inventor: Hiroshi Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/100,550

(22) Filed: Apr. 7, 2005

Related U.S. Application Data
(63) Continuation of application No. PCT/JP03/05306, filed on Apr. 24, 2003.

(51) Int. Cl. G06K 9/00

(52) U.S. Cl. 382/187

(57) ABSTRACT

An online handwritten character input device and a method therefor are provided, enabling the writing of handwritten character strings without the interruption of the writing even when the characters should be written on a small display. With this method, handwriting data of a handwritten character string written on a screen is input and stored, and the stored handwriting data is displayed on the screen. Determination is performed as to which portion of the stored handwriting data has been already written, and display of the portion of the handwriting data determined as already-written is erased from the screen or is controlled in accordance with display attribute information.

### TECHNICAL FIELD

The present invention relates to a handwritten character input device that stores handwriting data of characters written with a stylus or the like by hand and recognizes the handwriting data by means of character code conversion so as to be utilized on a computer. The present invention particularly relates to a box-free handwritten character input device enabling the writing at free positions without the use of a writing box during the writing of characters by handwriting.

### BACKGROUND ART

The rapid development of computer technology in these years has made it possible to enhance the speedup and the miniaturization of a computer itself, and a mobile terminal such as a personal digital assistant (PDA) also is becoming in common use. Under such circumstances, especially for a small mobile terminal, an online handwritten character input device having input means using handwritten characters and not key entry is used often because of the physical constraints of an input medium.

In many conventionally used online handwritten character input devices, particularly in devices performing character recognition, boxes where handwritten characters are inputted (hereinafter also referred to as “writing boxes”) are used for determining breaks between characters. FIG. 1 shows an exemplary screen display of a conventional handwritten character recognition device having writing boxes. As shown in FIG. 1, writing boxes are set in an input area 11, and the handwriting described in a box is recognized as one character. Then, the results of the recognition are sequentially displayed on a recognition result display area 12.

In this case, in order to determine the completion of the writing of a handwritten character, the following methods are adopted, for example, to determine the completion of the writing of a handwritten character when a user presses a recognition button and to determine the completion of writing of a handwritten character when a certain time period (e.g., 1 second) has elapsed after the completion of the writing of the last stroke. As another possible method, a plurality of writing boxes are provided, and at the time when the starting of the writing in another writing box is detected, the preceding writing of the handwritten character is determined as completed.

Further, the Zaurus (R) Series, which is an electronic organizer produced by Sharp Corporation, for example is equipped with the Ink Wordprocessor function, by which handwriting of characters written in writing boxes are reduced in size while keeping their shapes so as to be inserted in a text. Such a handwritten character input device having the function of reducing the handwriting in size for display adopts the method of determining a breaking position of a character by using writing-box information and of storing and displaying the handwriting described in the preceding writing box at the time when the writing on the next writing box is started, thus enabling the continuous input of a lot of characters.

Meanwhile, various technologies for box-free character recognition also have been developed, by which a handwritten character string can be written at free positions without the use of a writing box. For example, “Box-free online character string recognition technique with the integration of segmentation, recognition and certainty of language” by Senda and two others (technical report of IEICE PRMU98-138, December 1998) (hereinafter called “non-patent document 1) and “Online box-free handwritten character string recognition based on stochastic model” by Fukushima and one other (technical report of IEICE PRMU98-139, December 1999) (hereinafter called “non-patent document 2) disclose such technologies. For example, as shown in FIG. 2A and FIG. 2B, in the box-free character recognition device that recognizes the handwriting of handwritten characters and converts the same into text, if the breaking position for handwritten characters is wrong, one handwritten character string can be recognized in different ways. That is, in FIG. 2A, the handwriting is recognized as “ [symbol] ”, while in FIG. 2B it is recognized as “ [symbol] ”. Therefore, the quality of the segmentation technology for handwritten characters significantly affects the recognition accuracy.

In non-patent document 1 and non-patent document 2, a handwritten character string input in an input area without any specified writing boxes is firstly divided into individual segments constituting separate characters, and character recognition is performed for each character area that is configured by combining the individual segments. Then, the combination with the maximum likelihood among the possible combinations of the character areas is regarded as the recognition result of the character string. That is, these methods are equivalent to the method of configuring the individual segments in a network form and finding the optimum path from the network as shown in FIG. 3.

Furthermore, according to the box-free recognition method that recognizes a handwritten character string written by hand collectively at one time, the handwritten character string to be input is written to have a certain length, and then character recognition is carried out. Therefore, a time lag occurs before the recognition result can be obtained. For instance, in the case where writing boxes are provided as shown in FIG. 4A, character recognition can be performed for each character. Thus, the final recognition result can be displayed simply in the recognition time for one character after the completion of the writing of the character in the last writing box. On the other hand, in the case where there are no writing boxes provided as shown in FIG. 4B, since the character recognition is started after the completion of the writing of the whole character string, the recognition time for three characters is required. Thus, a considerable difference occurs in the response time Δt, which is a time period required for displaying the final recognition result after the completion of the writing of the last character, and this becomes a factor of degrading the operability of the box-free character recognition.

In order to cope with such a problem in the box-free character recognition, “Realtime box-free online handwriting string recognition using layer-delayed segmentation method” by Tanaka and two others (technical report of IEICE PRMU2001-264, March 2002) (hereinafter called “non-patent document 3”) for example discloses the method of performing character recognition concurrently with the writing of handwritten characters, so as to allow the recognition result to be obtained during the writing of the handwritten characters even with the box-free recognition. A similar method is disclosed by JP 2002-203208 A (hereinafter called “patent document 1”) also.

When using such methods, in order that a user may confirm the character string to be recognized finally, determination by the user is required for indicating that the writing of the handwritten character string that the user intends has been finished. For this purpose, conventionally, a user presses a recognition button or a certain time period without any inputting of handwriting (timeout) is determined as the completion of the input.

Then, as disclosed in JP H05(1993)-73725 A (hereinafter called “patent document 2”), for example, the handwritten characters that have been already recognized and the handwritten characters that have not been recognized yet are displayed with different display colors, or the handwritten characters that have been already recognized are erased from the display at the time when the recognition has been finished, so as to facilitate the confirmation concerning the position at which the recognition of the handwritten characters has been finished.

Furthermore, “Online writing-box free character string recognition by candidate character lattice method” by Murase and two others (IEICE Transactions, J68-D, no. 4, 1985, pp 765-772) (hereinafter called “non-patent document 4”) discloses the method of displaying the last N strokes only of the handwritten character currently being written, which means that the stroke data input before is not displayed so as to avoid the display of handwriting from overlapping.

However, when using the method shown by non-patent document 3, for example, the following problem occurs: although this method allows the recognition result to be obtained during the writing of the handwritten character string, in the case where there is a physical constraint on the screen size as in a PDA or the like, a long character string cannot be written within one line. This case may be dealt with by folding the string on the screen for writing. However, if the screen is full of handwritten character string, the handwriting on the screen should be erased.

### DISCLOSURE OF THE INVENTION

Regarding the timing for erasing the handwriting on the screen, the following methods can be considered, for example, to detect a user's operation such as the pressing of a recognition button, or to erase the handwriting while performing a recognition processing in the case of the absence of pen-inputting for a certain time period (timeout). However, in either method, the writing operation of handwritten character strings should be interrupted for erasing the handwriting. If the writing of characters is continued without erasing the handwriting on the screen, the handwriting will overlap one another, thus making it illegible considerably.

In order to cope with such a problem, as disclosed in non-patent document 4, for example, the last N strokes only (N represents a natural number) of the handwriting of a character string currently being written are displayed, which means that the stroke data prior to the N strokes is not displayed so as to avoid the overlapping of the handwriting of the character string on the screen. However, since the number of strokes is different in each character, it can be considered that such a control method of displaying predetermined N-strokes only may cause the problem of excessively erasing the handwriting or leaving unnecessary portions, resulting in an unfriendly user interface in some cases.

The above-described problems hold true for the case where character recognition is not performed. That is, in order to input a handwritten character string continuously on a small screen without the use of writing boxes, some consideration is needed so that the handwriting written thereon does not interfere with the writing of the following handwritten characters.

In order to cope with the above-stated problems, it is an object of the present invention to provide an online handwritten character input device and such a method enabling continuous writing of a long handwritten character string without the interruption of the writing of the handwritten characters even when the characters should be written on a small display.

In order to fulfill the above-stated object, the online handwritten character input device of the present invention includes: a handwriting input unit for inputting handwriting data of a handwritten character string written on a screen; a box-free handwritten character storing unit that stores the handwriting data without using information concerning boxes where handwritten characters are inputted; and a handwriting display unit that displays the handwriting data on the screen. The online handwritten character input device further includes an already-written character determination unit that determines which portion of the handwriting data has been already written, and display of the portion of the handwriting data determined as already-written is erased from the screen.

In order to fulfill the above-stated object, another online handwritten character input device of the present invention includes: a handwriting input unit for inputting handwriting data of a handwritten character string written on a screen; a box-free handwritten character storing unit that stores the handwriting data without using information concerning boxes where handwritten characters are inputted; and a handwriting display unit that displays the handwriting data on the screen. The online handwritten character input device further includes: an already-written character determination unit that determines which portion of the stored handwriting data has been already written; and a display attribute generation unit that generates display attribute information that specifies display attributes of the handwriting data. In the box-free handwritten character storing unit, the display attribute information is stored to be paired with the handwriting data, and display of the portion of the handwriting data determined as already-written is controlled in accordance with the display attribute information.

With these configurations, even when the writing is to be conducted with box-free character strings continuously on a small screen as in a PDA, already-written handwriting data does not interfere with the input of the following handwritten characters, thus allowing the continuous writing of box-free character strings to be performed naturally.

Furthermore, in the online handwritten character input device of the present invention, preferably, the already-written character determination unit includes: a handwriting grouping unit that divides the handwriting data into a plurality of groups in predetermined units; an already-written group determination unit that determines whether each of the groups has been already-written or not; and an already-written handwriting output unit that assigns the display attribute information to the handwriting data in accordance with whether the group has been already written or not.

Furthermore, in the online handwritten character input device of the present invention, preferably, the already-written group determination unit determines: in the case of horizontal writing, a group spaced from a left end of stroke data now being written by a predetermined width or more as already-written, and in the case of vertical writing, a group spaced from an upper end of stroke data now being written by a predetermined width or more as already-written. With this configuration, even when the display attributes of the handwriting data determined as already-written have been changed on the screen, a user can feel quite normal for the inputting of handwritten character string.

Furthermore, in the online handwritten character input device of the present invention, preferably, the already-written character determination unit further includes a character size determination unit that determines sizes of characters in the handwriting data, and the already-written group determination unit performs determination concerning already-written or not in accordance with the sizes of the characters. This configuration allows the device to respond to the size of characters dynamically.

Furthermore, in the online handwritten character input device of the present invention, preferably, the already-written character determination unit further includes a new line starting position determination unit that determines a new line starting position in the handwriting data, and the already-written group determination unit performs determination of a group concerning already-written or not in accordance with the group being located in the same line as the handwriting data now being written or not.

Furthermore, in the online handwritten character input device of the present invention, preferably, the handwriting data belonging to a group determined as already-written is erased from the screen. This can avoid the interference with the inputting of new handwritten characters.

Preferably, the online handwritten character input device of the present invention further includes a box-free handwritten character recognition unit that recognizes the stored handwriting data without using information concerning writing boxes and outputs a character recognition result.

The present invention also is directed to software for executing the functions of the above-stated online handwritten character input device as the processing steps of a computer. More specifically, a computer-executable program of the present invention is to implement an online handwritten character input method including the steps of: inputting handwriting data of a handwritten character string written on a screen; storing the handwriting data without using information concerning writing boxes; and displaying the handwriting data on the screen. The method further includes the step of determining which portion of the handwriting data has been already written, and display of the portion of the handwriting data determined as already-written is erased from the screen.

Another computer-executable program of the present invention is to implement an online handwritten character input method including the steps of: inputting handwriting data of a handwritten character string written on a screen; storing the handwriting data without using information concerning writing boxes; and displaying the handwriting data on the screen. The method further includes the steps of: determining which portion of the handwriting data has been already written, and generating display attribute information that specifies display attributes of the handwriting data. The display attribute information is stored to be paired with the handwriting data, and display of the portion of the handwriting data determined as already-written is controlled in accordance with the display attribute information.

With these configurations, when such programs are loaded onto a computer and are executed, an online handwritten character input device can be embodied by which even when the writing is to be conducted with box-free character strings continuously on a small screen as in a PDA, already-written handwriting data does not interfere with the input of the following handwritten characters, thus allowing the continuous writing of box-free character strings to be performed naturally.

### BRIEF DESCRIPTION OF DRAWINGS

FIG. 1 shows an exemplary screen display of a handwritten character recognition device having writing boxes.

FIG. 2A and FIG. 2B show exemplary recognition results due to the difference between segmentation positions in box-free handwritten character recognition.

FIG. 3 is for explaining a box-free handwritten character recognition method.

FIG. 4A is for explaining a recognition time in the handwritten character recognition method with writing boxes, and FIG. 4B is for explaining a recognition time in the handwritten character recognition method without writing boxes.

FIG. 5 shows the configuration of an online handwritten character input device according to Embodiment 1 of the present invention.

FIG. 6 shows exemplary stroke data in the online handwritten character input device according to Embodiment 1 of the present invention.

FIG. 7 is for explaining the way to determine already-written characters in box-free handwritten character input.

FIG. 8 shows an exemplary configuration of an already-written character determination unit in the online handwritten character input device according to Embodiment 1 of the present invention.

FIG. 9 shows exemplary handwriting grouping in the online handwritten character input device according to Embodiment 1 of the present invention.

FIG. 10 shows exemplary already-written determination in the online handwritten character input device according to Embodiment 1 of the present invention.

FIG. 11 shows another configuration of the online handwritten character input device according to Embodiment 1 of the present invention.

FIG. 12 is a flowchart of the procedure in the online handwritten character input device according to Embodiment 1 of the present invention.

FIG. 13 shows an exemplary configuration of an already-written character determination unit in the online handwritten character input device according to Embodiment 2 of the present invention.

FIG. 14 is for explaining a character size in the online handwritten character input device according to Embodiment 2 of the present invention.

FIG. 15 shows an exemplary configuration of an already-written character determination unit in the online handwritten character input device according to Embodiment 3 of the present invention.

FIG. 16 is for explaining a new-line starting position determination procedure in the online handwritten character input device according to Embodiment 3 of the present invention.

FIG. 17 shows an exemplary computer environment.

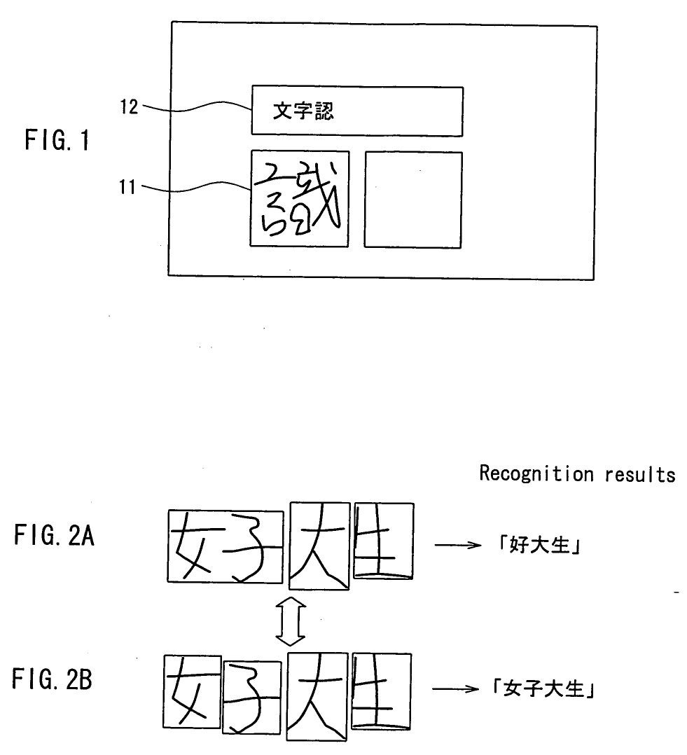

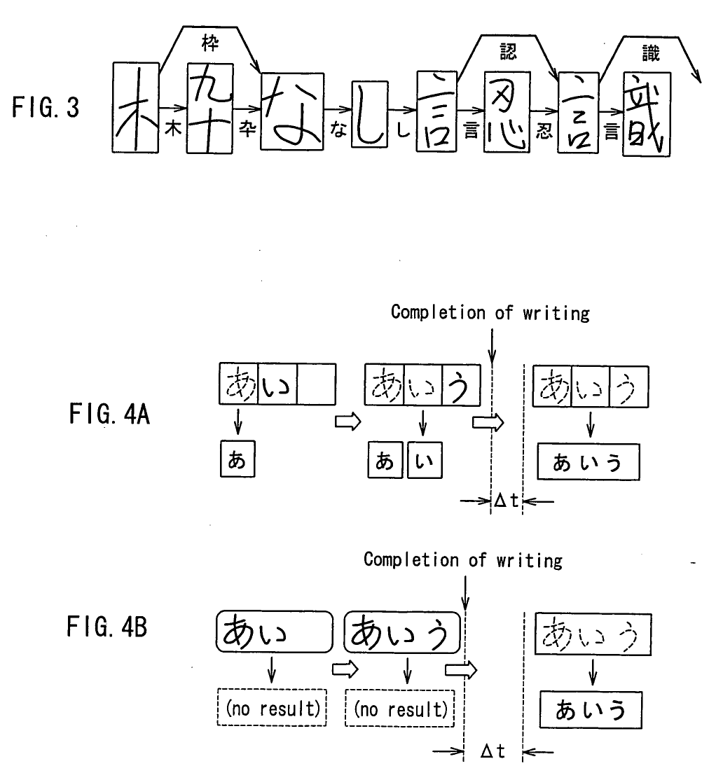

### BEST MODE FOR CARRYING OUT THE INVENTION

### Embodiment 1

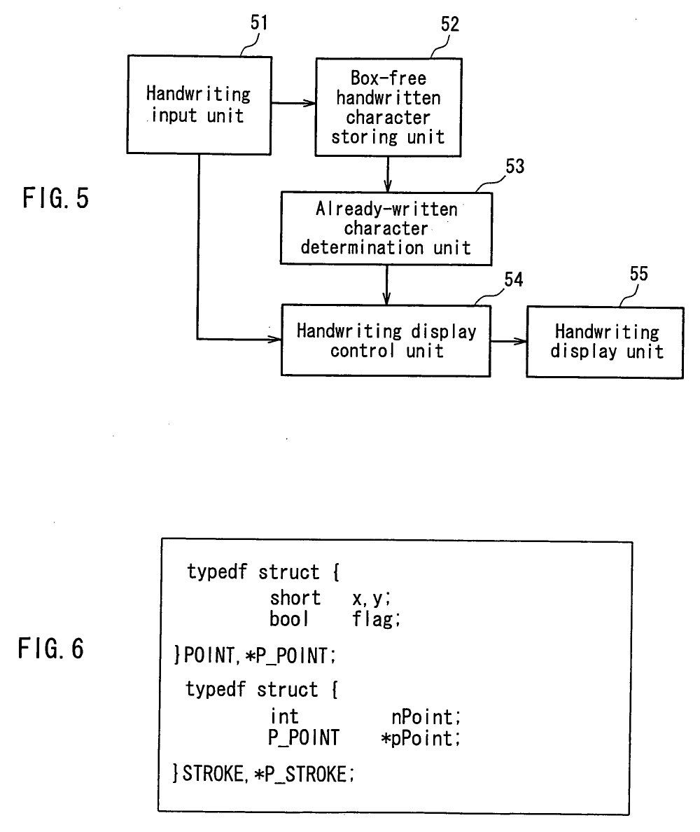

The following describes an online handwritten character input device according to Embodiment 1 of the present invention, with reference to the drawings. FIG. 5 shows the configuration of the online handwritten character input device according to Embodiment 1 of the present invention. In FIG. 5, reference numeral 51 denotes a handwriting input unit, which is an input medium such as a mouse or a pen-type tablet that enables the input of handwritten characters. The handwriting input unit 51 acquires coordinates data of the handwriting of the character string that a user writes. The acquired handwriting data is represented as an array of coordinates, which can be represented as a set of stroke data in the format as shown in FIG. 6, for example.

Reference numeral 52 denotes a box-free handwritten character storing unit, which stores handwriting data of the input handwritten characters and display attribute information that specifies screen display attributes of the handwriting data. More specifically, these data are recorded on a general storing means of a computer, and a storage device such as a hard disk is used for this purpose.

A handwriting display control unit 54 is a means for instructing a handwriting display unit 55 how to display the handwriting. For instance, among the handwriting data, coordinates data of those to be displayed and its display attributes (thicknesses, colors, line types, display/non-display of handwriting data, transmittances of the display, etc.,) are passed to the handwriting display unit 55. The handwriting display unit 55 displays the received data on the screen in accordance with its attributes, and a CRT display and a liquid crystal display of a computer, etc., are used for this purpose.

Herein, the display attribute information is generated in advance by a display attribute information generation unit (not illustrated). Then, the box-free handwritten character storing unit 52 updates the display attribute information as the need arises, depending on the status of the handwriting data, i.e., the handwriting data is in the process of writing or has been written already, etc. Thus, the display attribute information can be set in the unit of strokes or in the unit for determination concerning the completion of the writing, i.e., in the unit of words.

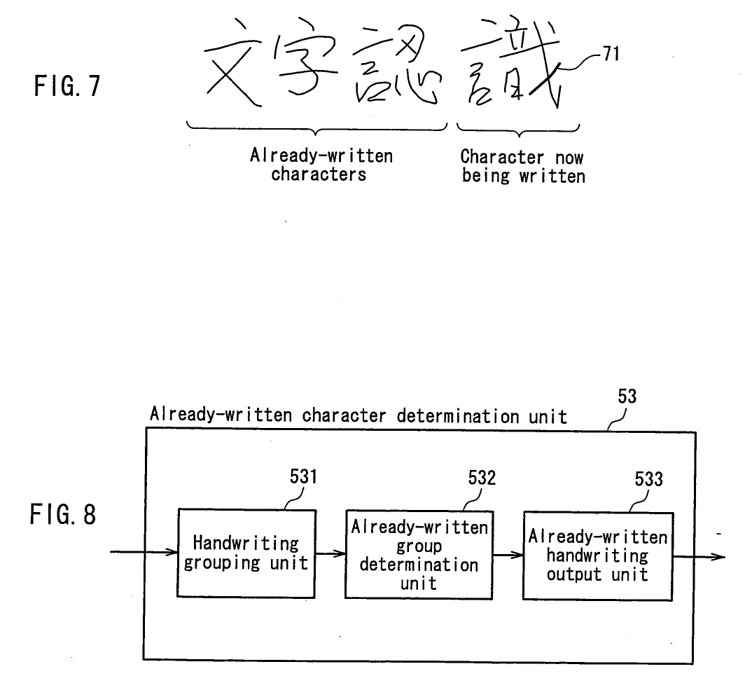

A feature of the present embodiment resides in that an already-written character determination unit 53 is provided. The already-written character determination unit 53 is a means for determining as already-written the handwriting belonging to a character that is different from the character now being written among the already stored handwriting data. For instance, in the case where the character string of [symbol] is to be input by handwriting as shown in FIG. 7, if the last stroke data 71 (the bold portion in FIG. 7) in the character [symbol] is now being written, the portion up to [symbol] is the already-written characters, and the character [symbol] is now being written. When the already-written handwriting is to be erased from the screen, the handwriting of [symbol] may be erased, but the handwriting belonging to [symbol] may not be erased. Thus, such a determination means is required. Note here that, in the case like cursive letters in English, determination may be performed for the unit of strokes, i.e., for the unit of one word, as to whether the writing has been finished or not.

FIG. 8 shows an exemplary configuration of the already-written character determination unit 53 in the online handwritten character input device according to Embodiment 1 of the present invention. In FIG. 8, a handwriting grouping unit 531 divides the stored handwriting data into a plurality of groups each constituting a character. Then, an already-written group determination unit 532 determines whether the writing of each group has been finished or not. Finally, an already-written handwriting output unit 533 outputs the handwriting data belonging to each group, along with the information indicating that the writing of the group has been finished or not.

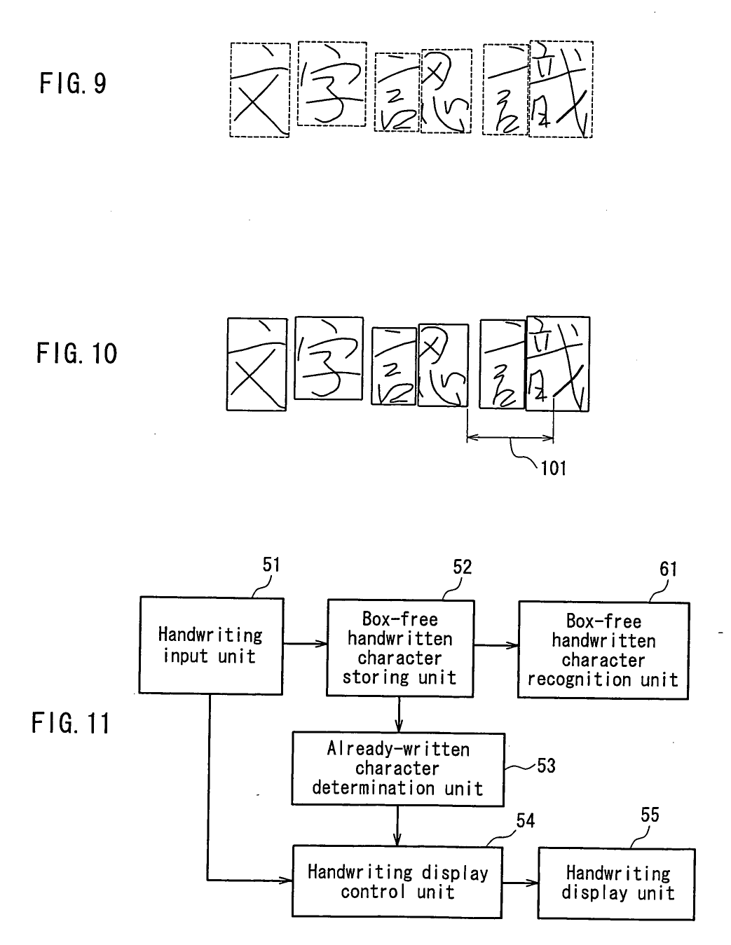

The handwriting grouping unit 531 can be implemented by using a segmentation technology that is used often for online box-free character recognition. Since the specific processing methods are mentioned in non-patent document 3 and non-patent document 4, the detailed explanations are omitted. For example, when subjected to the grouping, the handwriting is divided into groups, each made up of a portion being surrounded with a broken line shown in FIG. 9.

The already-written group determination unit 532, as shown in FIG. 10, determines as already-written the groups spaced from the left end of the handwriting currently being written by a certain width or more. In FIG. 10, the groups that are not included in an already-written determination size 101 are represented with bold solid lines, and these groups are determined as already-written. The setting method of the already-written determination size 101 is not limited particularly, and the value specified beforehand by the system may be used, for example, by setting with the actual size on the screen, e.g., at 2 cm.

Then, the already-written handwriting output unit 533 assigns a flag to each handwriting data, in which the flag is for dividing the handwriting into those belonging to the groups determined as already-written in FIG. 10 and the other handwriting, and passes the resultant to the handwriting display control unit 54. Such a procedure can be implemented easily by software.

Herein, the handwriting display control unit 54 controls the display method of the handwriting so that the handwriting belonging to the group determined as already-written does not interfere with the input of the following handwriting. For instance, the handwriting belonging to the group determined as already-written may be erased or the display attributes of such handwriting may be changed, e.g., to be displayed with a light color or a different color.

In the case where the display attributes of the handwriting data belonging to the group determined as already-written are to be changed, such a change can be implemented easily by setting the display attribute values as shown in Table 1 beforehand. Needless to say, the display attributes are not limited to those indicated in Table 1, and various attribute values can be used. Further, although the display attribute values are set for the unit of words in Table 1, these may be set for the unit of strokes.

TABLE 1

| | Thickness | | | Display/ |
|---|---|---|---|---|
| | (mm) | Color | Line types | Non-display |
| Display attributes | 2 | Black | Solid line | Display |
| for characters now | | | | |
| being written | | | | |
| Display attributes | 0.5 | Gray | Broken line | Display |
| for characters | | | | |
| determined as | | | | |
| already-written | | | | |

Furthermore, a character recognition function may be added to the above-described online handwritten character input device. In this case, as shown in FIG. 11, a box-free handwritten character recognition unit 61 recognizes the handwriting data stored in the box-free handwritten character storing unit 52. It should be noted that the box-free handwritten character recognition unit 61 has a function of outputting the recognition result onto a screen also.

The character recognition method by the box-free handwritten character recognition unit 61 is not limited particularly, and any conventionally available box-free handwritten character recognition method can be adopted.

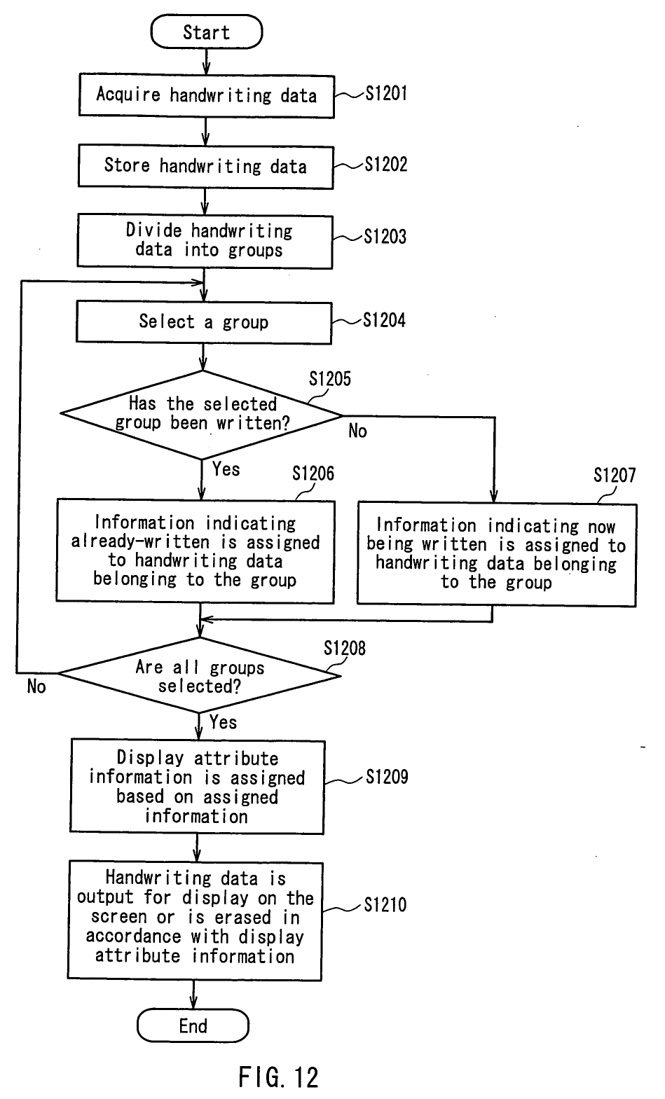

The following describes the flow of the procedure of a program that embodies the online handwritten character input device according to one embodiment of the present invention. FIG. 12 is a flowchart of the procedure of the program that embodies the online handwritten character input device according to one embodiment of the present invention.

In FIG. 12, firstly, handwriting data of a handwritten character string that a user writes is acquired (Step S1201) and is stored (Step S1202).

Next, the stored handwriting data is divided into a plurality of groups, each constituting a character (Step S1203). Then, a group that becomes a target of the determination as to whether the writing of the group has been finished or not is selected from the divided groups (Step S1204).

Then, the determination is performed as to whether the writing of the selected group has been finished or not (Step S1205). If it is determined as an already-written group (Step S1205: Yes), information indicating already-written is assigned to the handwriting data belonging to the group, where the assignment is carried out in the unit of words (Step S1206). If the group is determined as a not-written group (Step S1205: No), information indicating currently being written is assigned to the handwriting data belonging to the group in the unit of words (Step S1207). Such a procedure is repeated until all of the groups are selected (Step S1208).

Then, coordinates data of the handwriting data to be displayed and information concerning display attributes, such as thicknesses, colors, line types, display/non-display of lines and transmittances of characters for displaying the handwriting data on the screen, are added in accordance with the assigned information (Step S1209), and the handwriting data is displayed on the screen or is erased from the screen in accordance with the information concerning the display attributes (Step S1210).

As stated above, according to Embodiment 1, even when the writing is to be conducted with box-free character strings continuously on a small screen as in a PDA, already-written handwriting data does not interfere with the input of the following handwritten characters, thus allowing the continuous writing of box-free character strings to be performed naturally. Further, the operation for erasing the handwriting data determined as already-written from the screen can be eliminated, and handwritten characters can be input with efficiency without the interruption of the writing.

### Embodiment 2

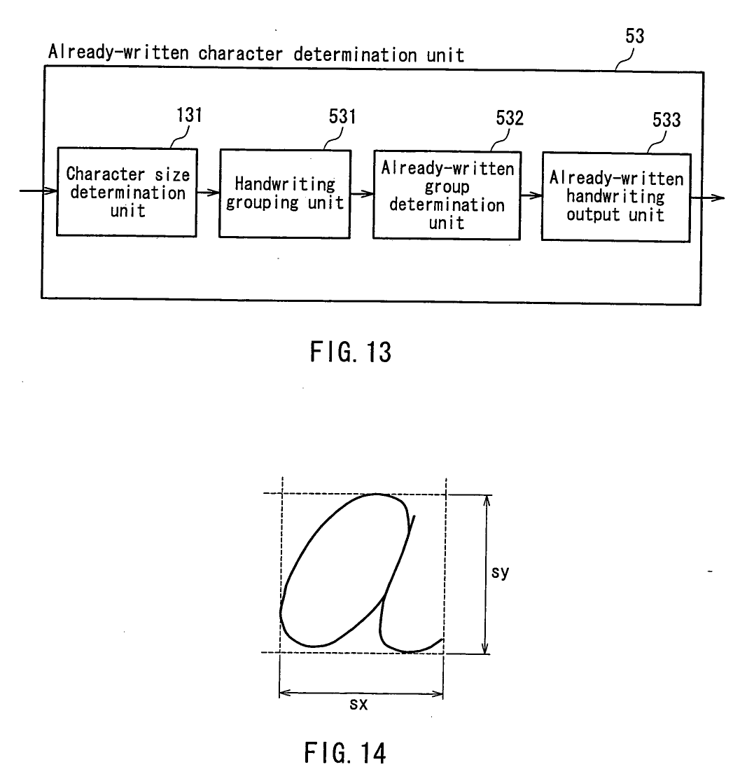

The following describes an online handwritten character input device according to Embodiment 2 of the present invention, with reference to the drawings. FIG. 13 shows the configuration of an already-written character determination unit 53 in the online handwritten character input device according to Embodiment 2 of the present invention.

As shown in FIG. 13, a feature of Embodiment 2 resides in that an already-written character determination unit 53, which corresponds to that in Embodiment 1, dynamically determines an already-written determination size 101 in accordance with the character size of a handwritten character string.

That is, in FIG. 13, the already-written character determination unit 53 is provided with a character size determination unit 131 that determines a size of characters of the input handwritten character string. The character size determination unit 131 determines the size of a handwritten character in accordance with the stored handwriting data of the handwritten character string.

Note here that the individual handwritten characters have various sizes and shapes. The “character size” referred to in Embodiment 2 means the numerical value indicating the average character size of the handwritten character string as a whole. For instance, as shown in FIG. 14, assuming that vertical and horizontal lengths of the outer dimensions of the handwritten character “a” are sy and sx, respectively, the larger value between them becomes the character size ss. That is, using the function MAX( ) for outputting the maximum value in the parenthesis, the character size ss can be represented as in (Formula 1):
ss=MAX(sx, sy) (Formula 1)

Then, an already-written group determination unit 532 determines whether the writing of the selected group has been finished or not in accordance with the character size ss determined by the character size determination unit 131. For instance, the following procedure can be performed: if a handwriting group includes the handwriting data located at a position twice or more the character size ss back from the stroke position currently being written, such a handwriting group can be determined as already-written.

That is, unlike Embodiment 1, the already-written determination size 101 is not a fixed value that is set beforehand but a variation that varies dynamically depending on the character size ss. For instance, the already-written determination size 101 for determining already-written or not may be set at, for example, 1.5 times the character size ss. Note here that the method for determining the already-written determination size 101 is not limited to a multiple of the character size ss, and any method can be used as long as it is determined based on the character size ss.

With such a configuration, the range concerning the determination of already-written or not can be varied dynamically in accordance with the size of input handwritten characters, thus allowing handwritten characters to be input continuously and in a more natural manner.

### Embodiment 3

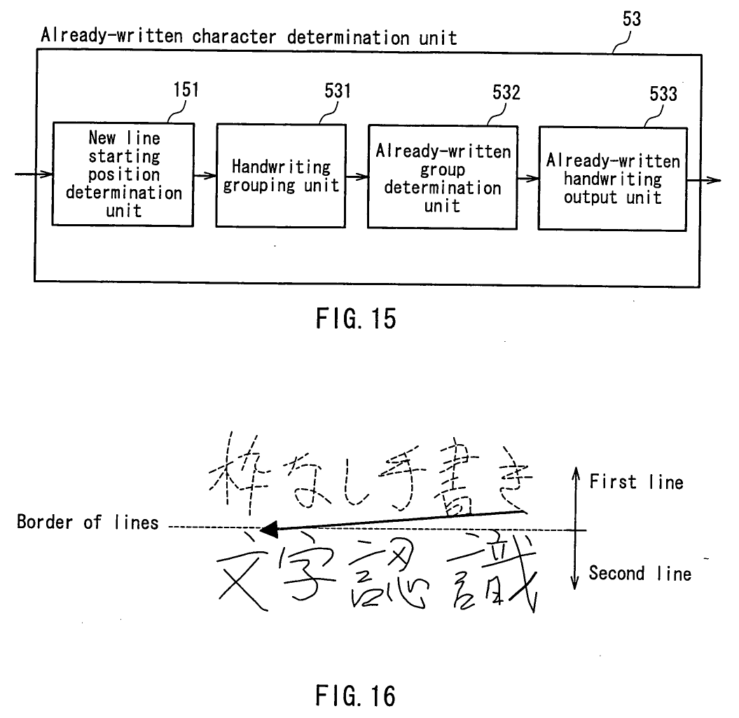

The following describes an online handwritten character input device according to Embodiment 3 of the present invention, with reference to the drawings. FIG. 15 shows an exemplary configuration of an already-written character determination unit 53 in the online handwritten character input device according to Embodiment 3 of the present invention.

Unlike Embodiments 1 and 2, a feature of Embodiment 3 resides in that determination is performed as to whether a new line is fed or not in a continuously input handwritten character string. That is, as shown in FIG. 15, the already-written character determination unit 53 is provided with a new line starting position determination unit 151, which determines the position at which lines are changed when a handwritten character string is continuously written in the unit of lines. Then, an already-written group determination unit 532 determines as already-written the handwriting groups belonging to the lines preceding the line that is determined as currently being written.

One example of the procedure in the new line starting position determination unit 151 will be described below, with reference to FIG. 16. FIG. 16 shows that the last stroke (indicated with the bold solid line) of the handwritten character [symbol] is now being written. In the example of FIG. 16, the handwritten character string is written in two separated lines.

Herein, the character string [symbol] in the second line is determined as currently written line and the character string [symbol] in the first line is determined as already-written. The character string [symbol] is represented with broken lines, which indicates that its display attribute has been changed because they are already-written.

Then, in FIG. 16, the movement vector of the pen from the end of the last stroke in the first line to the beginning of the first stroke in the second line is represented with a bold arrow. Such a vector shifted while detaching the pen is generally called off-stroke.

When inputting handwritten character strings, off-strokes are present between the strokes, and determination concerning the new line starting position can be performed using the directions and the sizes of the off-strokes.

For instance, in the case of horizontal writing, assuming that the component of an off-stroke in x-direction (assuming that the right side is positive) is ofx, the case of ofx>−2×ss can be determined as the new line starting position. In other words, when the writing position of characters is shifted significantly to the minus direction during the horizontally writing of the handwritten character string, such a position can be determined as the new line starting position.

Furthermore, many variations also can be considered, for example, determination may be performed with consideration also given to the case where a time interval between strokes, i.e., a time difference between the beginning and the ending of an off-stroke, exceeds a predetermined time period (e.g., 1 second) or with consideration given to the y component of the off-stroke ofy, for example, in the case where ofx>ss and ofy>0.5×ss, such a position may be determined as a new line starting position.

Similarly, in the case of vertical writing, assuming that the component of an off-stroke in y-direction (assuming that the down side is positive) is ofy, the case of ofy>−2×ss can be determined as the new line starting position. In other words, when the writing position of characters is shifted significantly to the minus direction during the vertically writing of the handwritten character string, such a position can be determined as the new line starting position.

Furthermore, many variations also can be considered, for example, determination may be performed with consideration also given to the case where a time interval between strokes, i.e., a time difference between the beginning and the ending of an off-stroke, exceeds a predetermined time period (e.g., 1 second) or with consideration given to the x component of the off-stroke ofx, for example, in the case where ofy>ss and ofx>0.5×ss, such a position may be determined as a new line starting position.

As stated above, according to Embodiment 3, when a long handwritten character string is to be input continuously, the writing can be performed while changing lines, whereby the already-written characters before changing the lines do not interfere with the input of new handwritten characters, thus enabling natural continuous writing.

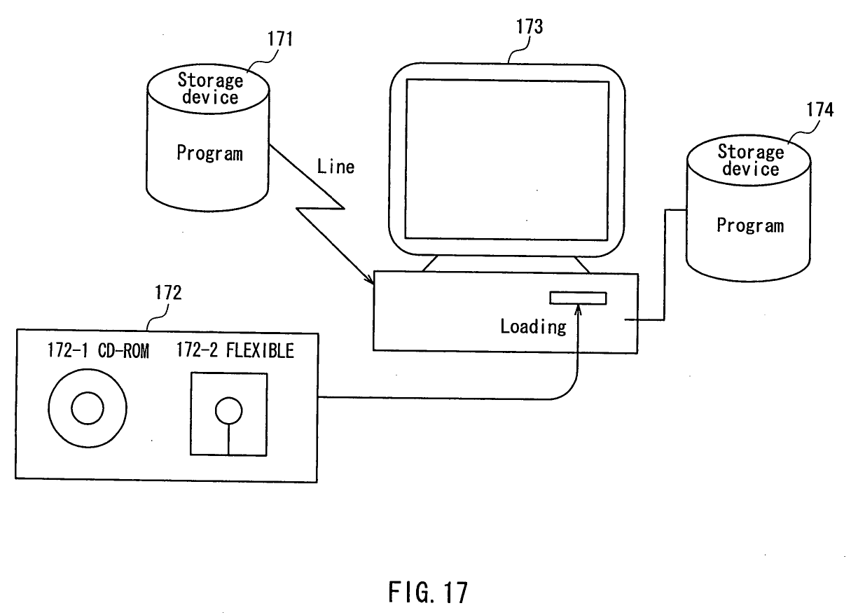

Note here that a program that embodies an online handwritten character input device according to embodiments of the present invention may be stored, as shown in FIG. 17, not only on a portable recording medium 172 such as a CD-ROM 172-1, a flexible disk 172-2 or the like but also on other storage devices 171 equipped at the forward of a telecommunication line and a recording medium 174 such as a hard disk and a RAM of a computer 173. When the program is executed, the program is loaded and is executed on a main memory.

Furthermore, the handwriting data or the like stored in the online handwritten character input device according to embodiments of the present invention also may be stored, as shown in FIG. 17, not only on the portable recording medium 172 such as the CD-ROM 172-1, the flexible disk 172-2 or the like but also on other storage devices 171 equipped at the forward of a telecommunication line and the recording medium 174 such as the hard disk and the RAM of the computer 173. For instance, when the online handwritten character input device according to the present invention is used, such data is read out by the computer 173.

### INDUSTRIAL APPLICABILITY

As stated above, according to an online handwritten character input device of the present invention, box-free character strings can be written continuously even on a small screen as in a PDA or the like, and even when handwriting data that is determined as already-written should be erased, there is no need to interrupt the input of the handwritten characters.

1. An online handwritten character input device, comprising:
a handwriting input unit for inputting handwriting data of a handwritten character string written on a screen;
a box-free handwritten character storing unit that stores the handwriting data without using information concerning boxes where handwritten characters are inputted; and
a handwriting display unit that displays the handwriting data on the screen,
wherein the online handwritten character input device further comprises an already-written character determination unit that determines which portion of the handwriting data has been already written, and
display of the portion of the handwriting data determined as already-written is erased from the screen.

2. An online handwritten character input device, comprising:
a handwriting input unit for inputting handwriting data of a handwritten character string written on a screen;
a box-free handwritten character storing unit that stores the handwriting data without using information concerning boxes where handwritten characters are inputted; and
a handwriting display unit that displays the handwriting data on the screen,
wherein the online handwritten character input device further comprises:
an already-written character determination unit that determines which portion of the stored handwriting data has been already written; and
a display attribute generation unit that generates display attribute information that specifies display attributes of the handwriting data,
wherein in the box-free handwritten character storing unit, the display attribute information is stored to be paired with the handwriting data, and
display of the portion of the handwriting data determined as already-written is controlled in accordance with the display attribute information.

3. The online handwritten character input device according to claim 1, wherein the already-written character determination unit comprises:
a handwriting grouping unit that divides the handwriting data into a plurality of groups in predetermined units;
an already-written group determination unit that determines whether each of the groups has been already written or not; and
an already-written handwriting output unit that assigns the display attribute information to the handwriting data in accordance with whether the group has been already written or not.

4. The online handwritten character input device according to claim 3, wherein the already-written group determination unit determines: in the case of horizontal writing, a group spaced from a left end of stroke data now being written by a predetermined width or more as already-written, and in the case of vertical writing, a group spaced from an upper end of stroke data now being written by a predetermined width or more as already-written.

5. The online handwritten character input device according to claim 3,
wherein the already-written character determination unit further comprises a character size determination unit that determines sizes of characters in the handwriting data, and
the already-written group determination unit performs determination concerning already-written or not in accordance with the sizes of the characters.

6. The online handwritten character input device according to claim 3,
wherein the already-written character determination unit further comprises a new line starting position determination unit that determines a new line starting position in the handwriting data, and
the already-written group determination unit performs determination of a group concerning already-written or not in accordance with the group being located in the same line as the handwriting data now being written or not.

7. The online handwritten character input device according to claim 2, wherein the handwriting data belonging to a group determined as already-written is erased from the screen.

8. The online handwritten character input device according to claim 1, further comprising a box-free handwritten character recognition unit that recognizes the stored handwriting data without using information concerning boxes where handwritten characters are inputted and outputs a character recognition result.

9. A computer-executable program that implements an online handwritten character input method comprising the steps of:
inputting handwriting data of handwritten characters string written on a screen;
storing the handwriting data without using information concerning boxes where handwritten characters are inputted; and
displaying the handwriting data on the screen,
wherein the method further comprises the step of:
determining which portion of the handwriting data has been already written, and
display of the portion of the handwriting data determined as already-written is erased from the screen.

10. A computer-executable program that implements an online handwritten character input method comprising the steps of:
inputting handwriting data of a handwritten character string written on a screen;
storing the handwriting data without using information concerning boxes where handwritten characters are inputted; and
displaying the handwriting data on the screen,
wherein the method further comprises the steps of:
determining which portion of the handwriting data has been already written, and
generating display attribute information that specifies display attributes of the handwriting data,
wherein the display attribute information is stored to be paired with the handwriting data, and
display of the portion of the handwriting data determined as already-written is controlled in accordance with the display attribute information.

11. The online handwritten character input device according to claim 4,
wherein the already-written character determination unit further comprises a new line starting position determination unit that determines a new line starting position in the handwriting data, and
the already-written group determination unit performs determination of a group concerning already-written or not in accordance with the group being located in the same line as the handwriting data now being written or not.

12. The online handwritten character input device according to claim 5,
wherein the already-written character determination unit further comprises a new line starting position determination unit that determines a new line starting position in the handwriting data, and
the already-written group determination unit performs determination of a group concerning already-written or not in accordance with the group being located in the same line as the handwriting data now being written or not.

13. The online handwritten character input device according to claim 3, wherein the handwriting data belonging to a group determined as already-written is erased from the screen.

14. The online handwritten character input device according to claim 4, wherein the handwriting data belonging to a group determined as already-written is erased from the screen.

15. The online handwritten character input device according to claim 5, wherein the handwriting data belonging to a group determined as already-written is erased from the screen.

16. The online handwritten character input device according to claim 6, wherein the handwriting data belonging to a group determined as already-written is erased from the screen.

17. The online handwritten character input device according to claim 2, further comprising a box-free handwritten character recognition unit that recognizes the stored handwriting data without using information concerning boxes where handwritten characters are inputted and outputs a character recognition result.

18. The online handwritten character input device according to claim 3, further comprising a box-free handwritten character recognition unit that recognizes the stored handwriting data without using information concerning boxes where handwritten characters are inputted and outputs a character recognition result.

19. The online handwritten character input device according to claim 4, further comprising a box-free handwritten character recognition unit that recognizes the stored handwriting data without using information concerning boxes where handwritten characters are inputted and outputs a character recognition result.

20. The online handwritten character input device according to claim 5, further comprising a box-free handwritten character recognition unit that recognizes the stored handwriting data without using information concerning boxes where handwritten characters are inputted and outputs a character recognition result.

21. The online handwritten character input device according to claim 6, further comprising a box-free handwritten character recognition unit that recognizes the stored handwriting data without using information concerning boxes where handwritten characters are inputted and outputs a character recognition result.

22. The online handwritten character input device according to claim 7, further comprising a box-free handwritten character recognition unit that recognizes the stored handwriting data without using information concerning boxes where handwritten characters are inputted and outputs a character recognition result.
